(19) United States
(12) Patent Application Publication
(10) Pub. No.: US 2019/0080116 A1
(43) Pub. Date: Mar. 14, 2019

(54) RANDOM NOISE BASED PRIVACY MECHANISM

(71) Applicant: Microsoft Technology Licensing, LLC, Redmond, WA (US)

(72) Inventors: Krishnaram Kenthapadi, Sunnyvale, CA (US); Thanh Thi Lac Tran, San Francisco, CA (US); Mark Dietz, Omaha, NE (US); Taylor Greason, San Francisco, CA (US); Ian Vaughn Koeppe, Omaha, NE (US)

(21) Appl. No.: 15/703,834

(22) Filed: Sep. 13, 2017

(51) Int. Cl. G06F 21/62; H04L 9/08

(52) U.S. Cl. CPC G06F 21/6254; G06Q 30/02; H04L 9/0869

(57) ABSTRACT

Techniques are provided for anonymizing statistical reports to protect user privacy. In one embodiment, a first request to view an aggregated statistic pertaining to online behavior of multiple users is received. In response to receiving the first request, a plurality of attributes associated with the first request is determined; a function is applied that accepts a seed value and the plurality of attributes to generate a number; a particular noise factor is determined based on the number and a distribution of noise factors; a true value for the aggregated statistic is determined; a noisy value that is different than the true value is determined based on the true value and the particular noise factor; and the noisy value is presented in response to the first request instead of the true value.

### TECHNICAL FIELD

The present disclosure relates to statistical reporting in a computing environment and, more particularly, to anonymizing statistics to protect user privacy.

### BACKGROUND

Content providers seeking to reach particular demographic groups often rely on statistical reports to determine how well particular content items are reaching targeted groups as well as how particular groups are responding to content items. For example, a report may indicate how many people clicked on a content item in a computer interface. To be of value to content providers, such reports gather personal information of users who have encountered or responded to content items. While these reports may be anonymized to some extent to protect user privacy, such reports may in many cases reveal information that can be used to identify and inappropriately track activities of individual users.

For example, real time reporting allows a content provider to determine when a single event (e.g., an impression, clicking on an online advertisement, etc.) occurs as well as which demographic dimensions changed as a result of the event. Moreover, while some reports may indicate events in groups (e.g., reporting events in a groups of 10), content providers can create fake accounts that generate false events that can be identified and removed to isolate data associated with real accounts. Thus, improved data anonymization is needed that provides greater protection of users while also providing useful information for content providers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a flow diagram that depicts a process for how a noise factor can be applied to aggregated statistics, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Statistical reports of user interaction data may be anonymized through application of a noise factor to generate a noisy value. The noise factor represents a number of statistical counts to be added or removed from the statistical report and may be based on a request for a statistical report. A statistical report may include several attributes that define which statistics should be included in the report. The noise factor may be generated based on the attributes and a seed value. The seed value may be a randomly generated value that can be used to generate multiple noise factors in response to multiple requests. The noise factor value may be selected from a distribution of possible values based on the attributes and seed value. One or more consistency checks may be applied to determine whether the noisy value should be modified or even withheld from reporting. Noisy values may also be generated based on other noisy values.

### System Overview

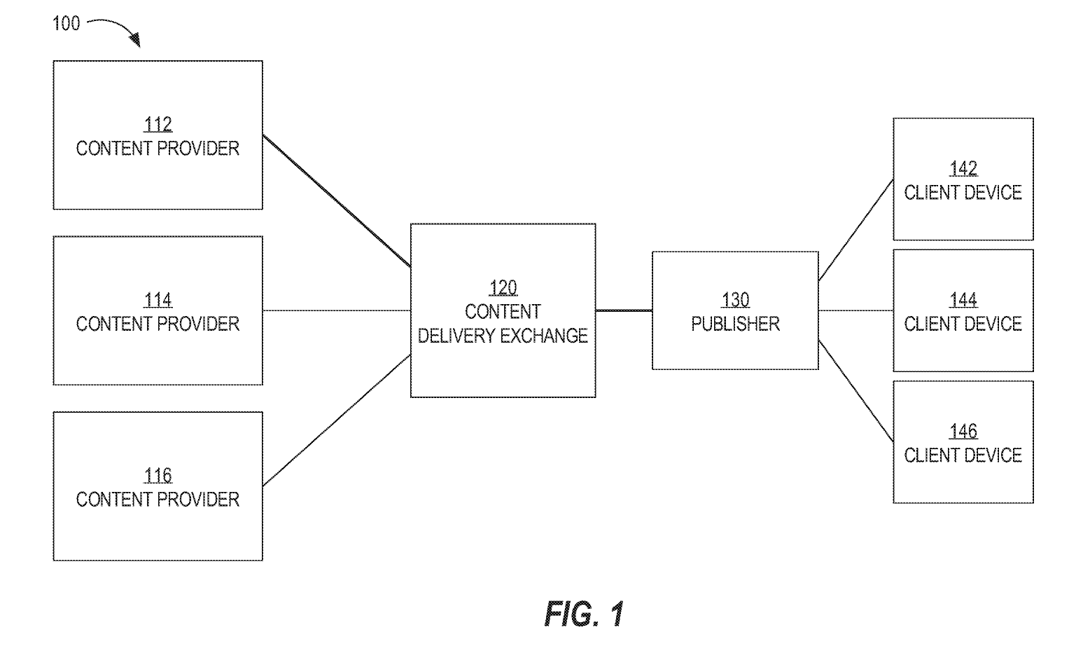

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Although depicted in a single element, content delivery exchange may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery campaign 120 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a resource budget that indicates how much the corresponding content provider is willing to be charged by content delivery exchange 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items are considered and a subset selected for presentation on a computing device in response to a request. Thus, each content request that content delivery exchange 120 receives triggers a content item selection event.

Specifically, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event, information such as the minimum winning bid or the highest bid of the content item that was not selected during the content item selection event.

### Tracking User Interaction

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device.

Other types of user interactions include following an individual or a company, liking a particular article or online posting, commenting on a particular article or online posting, filling out an electronic form, subscribing for a service, and purchasing a product.

### Data Anonymization

User interaction data may be stored and reported to content providers (e.g., campaign owners) periodically or in response to a request in the form of a query. A request may specify one or more attributes that define which data is to be reported. Attributes may include a type of user interaction data (e.g., clicks or impressions), time ranges, demographic dimensions (e.g., job title, industry, geographic location), and entity (e.g., content provider).

In some cases, statistics of user interaction data may only be reported if certain thresholds are reached. In one embodiment, a campaign manager interface may have a reporting threshold of ten counts for a given reporting period. That is, statistics may not be reported unless the statistics show a value that exceeds ten counts for any given demographic. For example, if a reporting period is one day and during a first day a “finance employee” demographic reported four clicks, an “engineering employee” demographic reported four clicks, and a “legal employee” demographic reported ten clicks, the “legal employee” statistics would be reported but not the “finance employee” or “engineering employee” statistics. If during a second day, the “finance employee” demographic reported six clicks, the “engineering employee” demographic reported four clicks, and the “legal employee” demographic reported one click, no statistics would be reported for the second day. However, if a query specifies a reporting period of the first and second day together, the “finance employee” statistics would be reported showing ten clicks and the “legal employee” statistics would be reported showing eleven clicks. Some clicks may apply to multiple demographic groups, for example, if an employee has multiple titles.

Periodic reports can utilize incremental thresholds to only report at the end of a period cycle if a number of events exceeds a threshold. For example, for an hourly report, if at the end of a first hour the number of events during the first hour does not exceed a given threshold, a report may not be generated at the end of the first hour. However, the events of the first hour may be carried over and added to events that occur during a second hour. If the combination of events still does not exceed the threshold, then the events from the first and second hours may be carried over into a third hour. If the number of events accumulated during an entire day do not exceed the threshold, then the events may not be reported at all and may be moved to storage.

Using thresholds as described can anonymize statistical information by ensuring that activities of individual users are not presented in isolation or in small groups. Reporting may be further anonymized in a variety of ways. Moreover, by accumulating statistics over multiple reporting periods, it can be difficult to determine which events apply to multiple demographic groups.

### Applying a Noise Factor

Data can be further anonymized through introduction of a noise factor. A noise factor indicates an amount of data to be added to or removed from a data set. By introducing a noise factor to a data set, it is more difficult to trace individual user activity represented in the data set.

For example, a data set may represent a true value of an aggregated statistic compiled in response to a request. Applying a noise factor to the data set results in a noisy value that is different than the accurate value. As used herein, a “true value” refers to a value of aggregated statistics to which a noise factor has not been applied. A “noisy value” refers to a value of aggregated statistics to which a noise factor has been applied.

A true value may be generated in response to a request for a statistical report. The true value may represent an accurate determination of statistics based on attributes included in the request. In an embodiment, a true value may be required to exceed a threshold in order for a report to be generated. For example, if the true value is less than ten, then no statistics may be reported. By doing so, some level of protection of individual privacy of users represented by the statistics is provided. In another embodiment, the true value may be required to exceed a threshold to allow a noise factor to be applied. For example, a true value of zero may not have any noise factor applied.

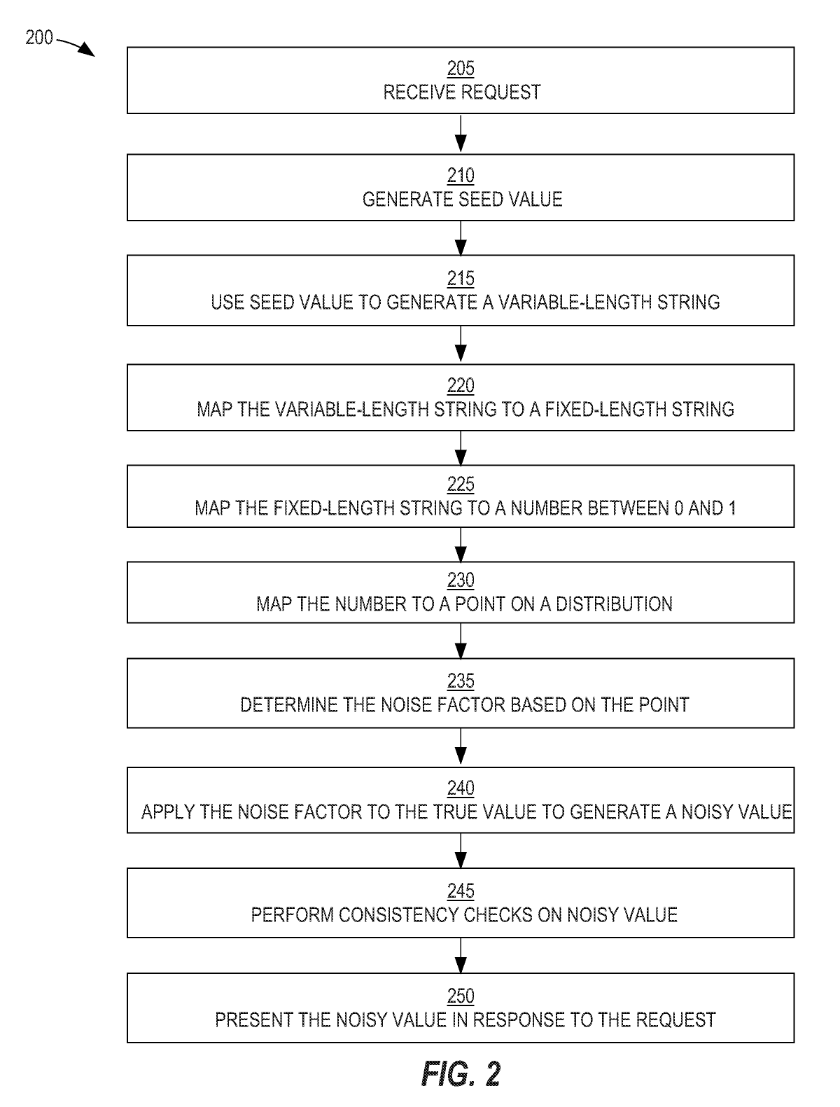

FIG. 2 is a flow diagram that depicts a process for how a noise factor can be applied to aggregated statistics, in an embodiment.

At block 205, a request for a report of aggregated statistics is received. The request may have a plurality of associated attributes that define the statistics to be aggregated. For example, attributes may include types of statistics (e.g., clicks, conversions), time ranges (e.g., a period of time in a single day, multiple days, multiple months), an identifier of the requesting entity, and demographic dimensions (e.g., age ranges, job titles).

At block 210, a seed value is generated. The seed value may be a randomly-generated value. A common seed value may be used for generating multiple noise factors. For example, in response to a first request for a first report of aggregated statistics, a first seed value may be generated and used to determine a first noise factor for the first report. In response to a second request for a second report of aggregated statistics, the first seed value may again be used to determine a second noise factor for the second report. Using a common seed value provides consistent noisy value generation. For example, a first noisy value may be generated to replace a true value in a first report based on defined attributes of a request. After the first noisy value is generated, additional statistics may be gathered that have identical attributes as the first set of statistics. That is, the additional statistics would have been included in the first report if the additional statistics had been gathered before the first report was generated. In this case, a new report may be generated that includes the additional statistics. Because of the common seed value, the new noisy value of the new report would be identical to the first noisy value.

At block 215, the seed value and attributes are used to generate a variable-length string. The variable-length string may be a concatenation of the seed value and one or more of the attributes. The variable-length string may be a set of numbers, characters, or a combination of numbers and characters.

At block 220, a hash function (e.g., a cryptographic hash function) may be applied to the variable-length string to generate a fixed-length string. For example, the variable-length string may be extended, truncated, or otherwise modified to generate the fixed-length string. The hash function may be consistent such that if two identical variable-length strings are inputted to the hash function, the two resulting fixed-length strings would also be identical.

At block 225, the fixed-length string is mapped to a value, for example, between 0 and 1 or between 0 and 10. The mapping may involve application of an additional hash function. For example, a subset of bits of the fixed-length string (e.g., the two least significant bits) may be used as the value.

At block 230, a point on a distribution is determined based on the value (e.g., between 0 and 1). The distribution may be a Gaussian, Laplace, or other type of distribution. There may be one-to-one mapping between the value and the point on the distribution. That is, each value may have a corresponding point on the distribution. The size and shape of the distribution can be variable and can be modified as needed. For example, a distribution may represent an unbounded range of values in which nearly all values are between negative 10 and positive 10 and a majority of values may be within the sub-range of negative 3 to positive 3. In an embodiment, the distribution may be adjusted based on the true value, such that a smaller true value typically results in a larger noise factor. Thus, there may be different distributions for different ranges of true values. For example, true values between 3 and 10 have a distribution range of 3, whereas true values between 11 and 20 have a distribution range of 4. A value may be rounded to the nearest integer value.

At block 235, a noise factor is determined based on the determined point. For example, each point on the distribution may correspond to a noise factor. A point in the middle of the distribution may correspond to a zero noise factor, points left of the middle may correspond to negative noise factors, and points right of the middle may correspond to positive noise factors.

Through use of a distribution, very large noise factors are avoided. For example, using a Laplace distribution with appropriate choice of parameters could ensure that a probability of computing a higher noise factor than positive three or lower than negative three would be approximately one percent. Additionally, using such distributions, the greater the value, the less likely the value would be computed as the noise factor. In this way, the noise factor provides desirable anonymity while avoiding excessive modification of the reported statistics.

Selecting noise factor values from a distribution is more effective than setting a maximum threshold of noise factor values. For example, a noise factor may be selected using a maximum threshold of two. A request may specify a particular title and a particular company that has six employees having the particular title. If the reported noisy value were eight, based on the maximum threshold it could be inferred that exactly six of the reported eight values were the six employees having the particular title, thus revealing the employees' identities. By applying a distribution, greater anonymity for the employees is achieved.

At block 240, the noise factor is applied to the true value to generate a noisy value. For a negative noise factor, the true value may be decreased by the given amount while for a positive noise factor, the true value may be increased by the given amount. The resulting value is the noisy value.

At block 245, one or more consistency checks (described in detail below) may be applied to the noisy value.

At block 250, the noisy value, rather than the true value, is presented in response to the request.

In an embodiment, two identical requests would result in identical noisy values. In such an embodiment, a common seed value may be used for both requests.

A noisy value may be generated in response to a request for statistical reports. The request may involve accessing multiple rows of a database table. However, a single noise factor may be generated for the multiple rows in response to the request. Additionally, individual rows or aggregated values that are below a reporting threshold can be reported in aggregate with other rows or values. In another embodiment, noisy values may be generated and stored in a database for each row. While doing so may improve simplicity in that noisy values may be easily accessed for future use, it may decrease efficiency by increasing the number of noisy values that are stored and aggregated.

A request may specify or require multiple aggregated statistics. That is, multiple statistical reports may be generated in response to a single request. As such, multiple noise factors and noisy values may be generated in response to a single request. Moreover, different distributions may be used for each true value of multiple true values generated in response to a single request.

A request may also specify or indicate an entity. Examples of entities in this context include a content provider, an account that the content provider establishes, a campaign group that is part of or assigned to an account, a content delivery campaign that is assigned to a campaign group, and a content item that is part of a content delivery campaign. An account is a sub-entity of a content provider, a campaign group is a sub-entity of an account, a content delivery campaign is a sub-entity of a campaign group, and a content item is a sub-entity of a content delivery campaign. Other embodiments may include more or less entities/sub-entities. For example, a related embodiment may not include campaign groups or accounts.

If an entity specified in a request has one or more sub-entities, then the noisy value generated in response to the request may be generated based on noisy values for the one or more sub-entities. For example, if a request specifies a particular account as the entity, and the particular account has multiple campaigns, individual noisy values for each of the multiple campaigns may be generated or retrieved from storage. The noisy values for the multiple campaigns may then be combined (e.g., added up) to generate a noisy value for the particular account. In an embodiment, the noisy value of an entity may only be based on noisy values of sub-entities if the number of sub-entities meets or exceeds a particular threshold value. For example, if an entity has more than three sub-entities, a noisy value for the entity may be generated based on noisy values of the sub-entities. Otherwise, a noisy value for the entity in not generated based on the noisy values of the sub-entities. Rather, a noisy value is generated directly based on the true value for the entity.

A request may have any combination of associated attributes. For example, a first request may be associated with a statistic type (e.g., impressions) and a date range (e.g., between May 22 and May 24). A second request may be associated with a statistic type, a date range, and a demographic dimension (e.g., a particular job title). Requests may be received from users (e.g., content providers) or may be generated automatically, for example on a daily basis.

### Consistency Checks

A consistency check is a determination of whether generated noisy values should be modified based on evaluation of the noisy value itself or related noisy values. There may be a variety of consistency checks. For example, it may be determined whether the noisy value is below zero. This may occur if the noise factor is a negative value that is greater than the true value. If the noisy value is below zero, then the noisy value may be changed to equal zero or the noise factor may not be applied.

Consistency checks may also be applied based on the entity identified in the request attributes. An entity may be any of a content provider, a particular account of a particular content provider, or a particular campaign of a particular account. An account may have multiple campaigns and a content provider may have multiple accounts. A consistency check may be applied to ensure that a sum of noisy values of a group of campaigns of a particular account do not exceed a noisy value of the particular account itself as well as that a sum of noisy values of a group of accounts of a particular content provider do not exceed a noisy value of the particular content provider.

For example, a first request may identify a particular account as the entity for the first request. A true value for the first request may represent all aggregated statistics for the particular account. A set of additional requests may each identify a different campaign of the particular account as the entity for the particular request. The combined true values of all of the additional requests may equal the aggregated statistics for the particular account (or in some cases may be different). However, the sum of the noisy values for all of the additional requests may be different than the noisy value for the first request. If the sum of the noisy values for all of the additional requests exceeds the noisy value for the first request, then the noisy values of one or more of the additional requests may be reduced such that the sum of the noisy values is equal to or less than the noisy value of the first request.

Consistency checks may also be applied within a single entity. For example, a first request may identify a first entity and a group of additional requests may identify the first entity as well. However, the first request may not specify a particular job title in the attributes of the first request (e.g., under demographic dimensions) while each of the additional requests specifies a different particular job title in the corresponding attributes of the additional request. A consistency check may be applied to ensure that a sum of the noisy values of the additional requests do not exceed the noisy value of the first request (which represents all possible job titles).

A consistency check may have a threshold value (e.g., number of sub-entities) for applying the consistency check. For example, for entities with a large number of sub-entities, noisy values of the sub-entities may be allowed to exceed the noisy value of the entity. If a particular account has more than three campaigns, there may not be a consistency check to ensure that a sum of the noisy values of the three campaigns is equal to or less than the noisy value of the particular account. The threshold value may be adjusted as desired.

In an embodiment, a first statistic type may be normalized with a second statistic type for a common entity over a common time range. For example, separate reports for a first entity over a first set of time ranges may provide numbers of clicks (i.e., first statistic type) and numbers of conversions (i.e., second statistic type). Noisy values may be computed for each statistic type. If a sum of noisy values of the conversions exceeds a sum of noisy values of the clicks, then the sum of noisy values of the conversions may be capped to be equal to or less than the sum of noisy values of the clicks.

### Time Range Hierarchy

A noisy value for a period defined by a time range may be based on a time range hierarchy. For example, a request for a statistical report may have a time range attribute that defines the range of March 28 through May 8. One option of generating a noisy value for this range is to determine a true value for each day in the range, generate a noisy value for each day based on the true value, and add up the noisy values to generate a total noisy value. However, because doing so would require generating and summing a large number of noisy values, it may be more efficient to reduce the number of noisy values. Moreover, reducing the number of noisy values may also allow for providing content providers with noisy values that are closer to the corresponding true values while still providing adequate privacy protection. This may be accomplished by applying a time range hierarchy.

A time range hierarchy may define a ranking of time ranges. For example, the hierarchy may rank larger time ranges higher than smaller ranges. In this case, year would rank higher than month, month would rank higher than week, week would rank higher than day, day would rank higher than hour, and so on. The hierarchy may be used to determine which noisy values to generate.

For example, in the time range of March 28 through May 8, because months rank higher than weeks and days, the entire month of April may be used to generate a single noisy value. That is, all statistics for the month of April that satisfy the other attributes of the request may be compiled into a single true value, and the true value may be used to generate a single noisy value based on a single noisy factor. Additionally, because weeks rank higher than days, the first seven days of May can be grouped into a week, a single noisy value may be generated for the period from May 1 through May 7. The dates March 28, March 29, March 30, March 31, and May 8 can each be considered individual days, meaning that an individual noisy value would be generated for each of these days. Accordingly, the time range of March 28 through May 8 would result in seven noisy values: one month, one week, and five days. An overall noisy value for the time range may be generated based on the seven noisy values (e.g., by summing the seven noisy values).

Noisy values may also be generated based on multiple noisy values having differing granularities in terms of entity. For example, a noisy value for a particular content provider may be based on a (1) noisy value of a first content deliver campaign of the particular content provider and (2) individual noisy values of one or more content items of a second content delivery campaign of the particular content provider.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

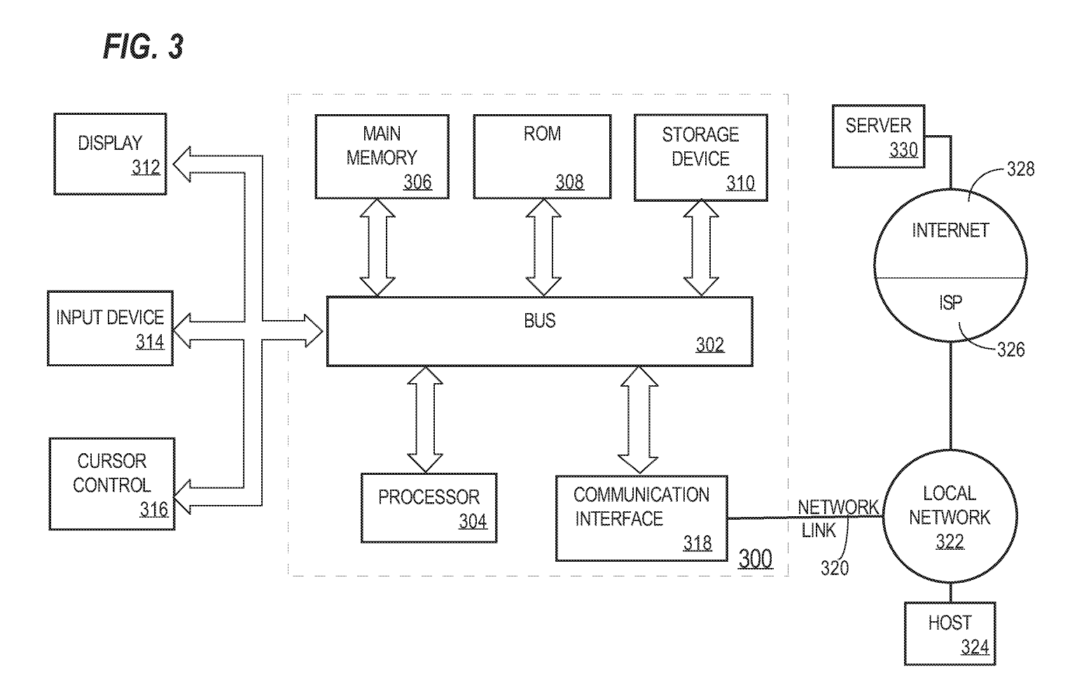

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause;
receiving a first request to view an aggregated statistic pertaining to online behavior of multiple users;
in response to receiving the first request:
determining a plurality of attributes associated with the first request;
using a function that accepts a seed value and the plurality of attributes to generate a number;
determining, based on the number and a distribution of noise factors, a particular noise factor;
determining a true value for the aggregated statistic;
determining, based on the true value and the particular noise factor, a noisy value that is different than the true value;
causing the noisy value to be presented in response to the first request instead of the true value.

2. The system of claim 1, wherein the instructions, when executed by the one or more processors, further cause:
receiving a second request to view the aggregated statistic pertaining to the online behavior of multiple users;
in response to receiving the second request:
determining the plurality of attributes associated with the second request;
using the function that accepts the seed value and the plurality of attributes to generate the number;
determining, based on the number and the distribution of noise values, the particular noise factor;
determining the true value for the aggregated statistic;
determining, based on the true value and the particular noise factor, the noisy value;
causing the noisy value to be presented in response to the second request instead of the true value.

3. The system of claim 1, wherein the plurality of attributes include two or more of a type of statistic from among a plurality of possible types of statistics, a time range from among a plurality of possible time ranges, an entity identifier from among a plurality of entity identifiers, a demographic dimension from among a plurality of demographic dimensions.

4. The system of claim 3, wherein the plurality of possible types of statistics include impressions, clicks, or conversions.

5. The system of claim 3, wherein the plurality of demographic dimensions include job title, industry, and geographic location.

6. The system of claim 3, wherein the plurality of entity identifiers include two or more of identifiers of multiple content providers, identifiers of accounts of the multiple content providers, identifiers of content delivery campaigns initiated by the multiple content providers, or identifiers of content items of the content delivery campaigns.

7. system of claim 3, wherein the plurality of possible time ranges include two or more of specific hours, specific days, specific weeks, specific months, or specific years.

8. The system of claim 1, wherein the aggregated statistic is a first aggregated statistic, wherein the first request is to also view a second aggregated statistic that is different than the first aggregated statistic, wherein the instructions, when executed by the one or more processors, further cause:
in response to receiving the first request:
determining a second plurality of attributes associated with the first request;
using the function that accepts the seed value and the second plurality of attributes to generate a second number;
determining, based on the second number and the distribution of noise values, a second particular noise factor;
determining a second true value for the second aggregated statistic;
determining, based on the second true value and the second particular noise factor, a second noisy value that is different than the second true value;
causing the second noisy value to be presented in response to the first request instead of the second true value.

9. The system of claim 1, wherein the seed value is a randomly generated value.

10. A system comprising:
one or more processors;
one or more storage media storing instructions which, when processed by the one or more processors, cause:
determining to generate a noisy value of an aggregated statistic pertaining to online behavior of multiple users, wherein the aggregated statistic is associated with a particular entity that is associated with a plurality of sub-entities;
determining whether a number of sub-entities in the plurality of sub-entities is less than a particular threshold;
if the number of sub-entities is less than the particular threshold, then generating the noisy value based on a separate noisy value associated with each sub-entity of the plurality of sub-entities;
if the number of sub-entities is greater than the particular threshold, then generating the noisy value based on a true value of the aggregated statistic.

11. The system of claim 10, wherein:
the particular entity is one of a particular content provider, a particular account of the particular content provider, or a particular content delivery campaign of the particular account,
the plurality of sub-entities is a plurality of accounts if the particular entity is the particular content provider, a plurality of content delivery campaigns if the particular entity is the particular account, or a plurality of content items if the particular entity is the particular content delivery campaign.

12. The system of claim 10, wherein the instructions, when processed by the one or more processors, further cause:
if the number of sub-entities is greater than the particular threshold:
using a function that accepts a seed value and an entity identifier of the particular entity to generate a number;
determining, based on the number and a distribution of noise factors, a particular noise factor;
determining a true value for the aggregated statistic; and
determining, based on the true value and the particular noise factor, the noisy value of the aggregated statistic, wherein the noisy value is different than the true value.

13. The system of claim 10, wherein the instructions, when processed by the one or more processors, further cause:
if the number of sub-entities is less than the particular threshold, for each sub-entity of the plurality of sub-entities:
using a function that accepts a seed value and an entity identifier of the sub-entity to generate a number;
determining, based on the number and a distribution of noise factors, a particular noise factor;
determining a true value for at least a portion of the aggregated statistic; and
determining, based on the true value and the particular noise factor, the separate noisy value associated with the sub-entity, wherein the separate noisy value is different than the true value; and
generating the noisy value based on the separate noisy value.

14. The system of claim 13, wherein the seed value is a randomly generated value.

15. A system comprising:
one or more processors;
one or more storage media storing instructions which, when processed by the one or more processors, cause:
generating a noisy value of an aggregated statistic pertaining to online behavior of multiple users;
wherein the noisy value is based on a plurality of noisy values that includes a first noisy value of a first aggregated statistic and a second noisy value of a second aggregated statistic that is different than the first aggregated statistic;
wherein the first aggregated statistic is at a first level of granularity and the second aggregated statistic is at a second level of granularity that is higher than the first level of granularity;
wherein the first noisy value is generated based on a first true value of the first aggregated statistic that is at a first level of granularity;
wherein the second noisy value is generated based on a second true value of the second aggregated statistic, wherein the second true value is calculated based on a plurality of true values of a plurality of aggregated statistics that are at the first level of granularity.

16. The system of claim 15, wherein the first level of granularity corresponds to a first time range and the second level of granularity corresponds to a second time range that is longer than the first time range.

17. The system of claim 15, wherein the first level of granularity corresponds to a first type of entity and the second level of granularity corresponds to a second type of entity that is different than the first type of entity.

18. The system of claim 17, wherein:
the second aggregated statistic corresponds to one of a first particular content provider, a first particular account of the first content provider, or a first particular content delivery campaign of the first particular account,
the first aggregated statistic corresponds to one of a second particular account if the second aggregated statistic corresponds to the first particular content provider, a second particular content delivery campaign if the second aggregated statistic corresponds to the first particular account, or a second particular content item if the second aggregated statistic corresponds to the first particular content delivery campaign.
